(19) United States
(12) Patent Application Publication
(10) Pub. No.: US 2004/0088924 A1
(43) Pub. Date: May 13, 2004

(54) Carriage for a window lifter

(76) Inventors: Jurgen Moser, Braunschweig (DE); Markus Waroch, Rotgesbuttel (DE)

Correspondence Address: CARLSON, GASKEY & OLDS, P.C., 400 WEST MAPLE ROAD, SUITE 350, BIRMINGHAM, MI, 48009, US

(21) Appl. No.: 10/649,325

(22) Filed: Aug. 27, 2003

(30) Foreign Application Priority Data
Aug. 29, 2002 (DE) 102 39 779.1

(51) Int. Cl. B60J 1/16

(52) U.S. Cl. 49/375

(57) ABSTRACT

This invention relates to a carriage for a window lifter, comprising a base part, which is provided for being movably mounted on a rail which can be mounted in a vehicle, and a clamping part which is mounted on the base part, so that a vehicle pane to be adjusted can be clamped between the base part and the clamping part, wherein an arresting mechanism is provided, by means of which the clamping part can be mounted at the base part in different positions which each correspond to a different mounting situation.

### REFERENCE TO RELATED APPLICATIONS

The present invention claims the benefit of German Patent Application No. 102 39 779.1, filed Aug. 29, 2002.

### TECHNICAL FIELD

This invention relates to a carriage for a window lifter, comprising a base part which is provided for being movably mounted on a rail which can be installed in a vehicle, and a clamping part which is mounted on the base part so that a vehicle pane to be adjusted can be clamped between the base part and the clamping part.

### BACKGROUND OF THE INVENTION

Carriages for window lifters usually comprise a base part that is movably mounted on a rail and that can be installed in a vehicle and a clamping part which is mounted on the base part so that a vehicle pane to be adjusted can be clamped between the base part and the clamping part. The carriage is a well-known component in conventional cable-actuated window lifters which are used in motor vehicles. This window lifter usually has two rails which are for instance installed in a vehicle door and on each of which a carriage is mounted. In the two carriages, the lower edge of a window pane is clamped, so that it can be adjusted in the vehicle door. It is known that the carriage structures require four different versions, namely one version each for the front rail on the left side of the vehicle, for the front rail on the right side of the vehicle, for the rear rail on the left side of the vehicle, and for the rear rail on the right side of the vehicle.

It is the object of the invention to develop a carriage that eliminates the need for multiple carriage structures for different mounting positions.

### SUMMARY OF THE INVENTION

For this purpose, an arresting mechanism in accordance with the invention has a clamping part that can be mounted on a base part in different positions that each correspond to a different mounting orientation. This allows for mounting of the same carriage in different positions on the four different rails and mounting of the clamping part with the arresting mechanism on the base part in the corresponding, suitable position. This reduces the costs of the window lifter, as it is no longer necessary to produce four different versions of carriages for the different positions and orientations. Instead, a single carriage structure can be mounted in different positions to accommodate the different orientations.

In one embodiment, the arresting mechanism includes a clamping screw which can be screwed into a bore in the base part so that the clamping part can be tensioned against the base part. Thus, the clamping screw has a dual function; on the one hand, it clamps the window pane between the clamping part and the base part in a conventional way as part of the arresting mechanism, and on the other hand, it holds the clamping part in one of the defined positions.

In accordance with one embodiment of the invention, the arresting mechanism contains a plurality of recesses and a tab which, depending on the desired mounting orientation, engages in one of the recesses so that the clamping part can be mounted at the base part in precisely defined positions. This represents an economical option for defining the different positions of the clamping part at the base part, in particular when the tab is formed at one end of the clamping part and the recesses are provided in the base part. The recesses may be made in the surface of the base part without impairing the strength, and the tab can be punched out from the outer edge of the clamping part.

In accordance with another embodiment of the invention, the arresting mechanism includes an elongate recess and a tab which, depending on the mounting orientation, takes a different position in the elongate recess. The recess preferably is arcuate and the center of curvature of the recess coinciding with the center of the clamping screw. Hence, it is possible that the clamping part aligns itself on its own with the window pane during assembly, which considerably reduces the mounting effort.

In accordance with one embodiment of the invention, the carriage is symmetrical with respect to its longitudinal axis extending through the bore for the clamping screw. This allows to mount the carriage on the rail in different orientations.

### BRIEF DESCRIPTION OF THE DRAWINGS

The invention will subsequently be described with reference to two preferred embodiments which are represented in the attached drawings, in which:

FIG. 1 is a schematic view of a carriage in accordance with a first embodiment of the invention;

FIG. 2 is a perspective exploded view of the components of the carriage of FIG. 1;

FIG. 3 is a schematic view of two rails of a window lifter, which are each provided with a base part of a carriage in accordance with the first embodiment;

FIG. 4 illustrates the window lifter of FIG. 3, the two carriages now being provided with the clamping parts;

FIG. 5 is a section view along the plane V-V of FIG. 4;

FIG. 6 shows a perspective view of the base part and the clamping part for a carriage in accordance with a second embodiment of the invention;

FIG. 7 shows a perspective exploded view of the components of the carriage in accordance with the second embodiment;

FIG. 8 shows a perspective view of the carriage in accordance with the second embodiment in the installed condition;

FIG. 9 shows a first step of mounting a window pane in the carriage in accordance with the second embodiment;

FIG. 10 shows a second step of mounting a window pane in the carriage in accordance with the second embodiment; and

FIG. 11 shows the carriage in accordance with the second embodiment with the window pane mounted therein.

### DETAILED DESCRIPTION OF THE EMBODIMENTS

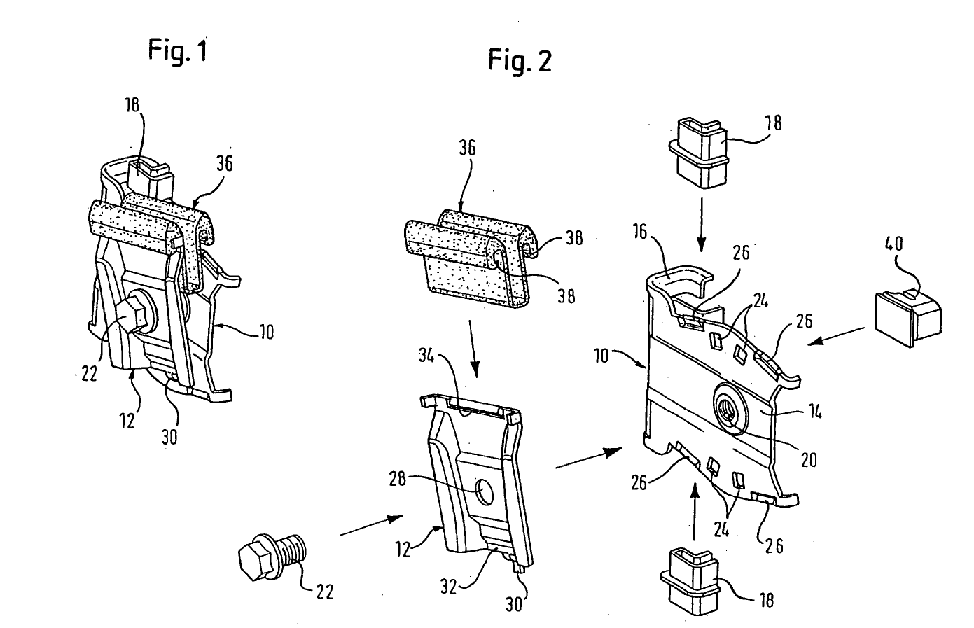

FIGS. 1 to 5 show a carriage according to one embodiment of the invention. As essential components, the carriage has a base part 10 and a clamping part 12 (shown in FIGS. 1 and 2). In one embodiment, both the base part 10 and the clamping part 12 are punched plate bending parts.

The base part 10 has a body portion 14 and a sliding portion 16. The sliding portion is movably mounted in a rail of a window lifter. Two sliding pieces 18 are inserted in the sliding portion 16. The sliding pieces 18 may be made of plastic and are designed to provide low-friction and low-noise guidance of the base part 10 along the rail.

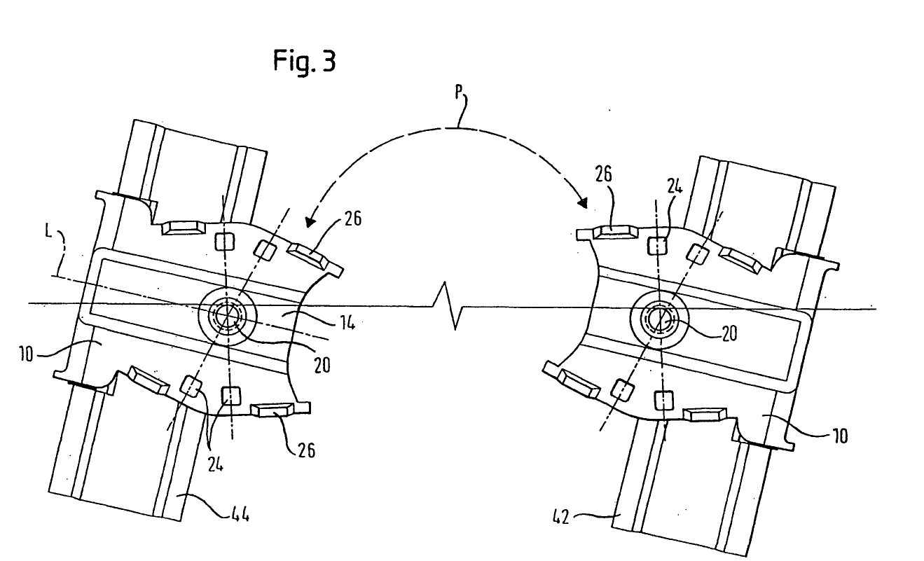

The body portion 14 is provided with a threaded bore 20 that accommodates a clamping screw 22. The body portion 14 furthermore is provided with four recesses 24, which are diametrically opposed in pairs with respect to the middle axis of the bore 20 (FIG. 3). In this example, the recesses 24 constitute punched holes having a generally square shape. At the outer edge of the body portion 14, there are also four barbs 26 which constitute an embossed portion. The barbs are designed such that the edges protruding from the plane of the body portion 14 point toward the middle of the body portion, namely on the side of the body portion which cannot be seen in FIG. 2. The recesses 24 and the barbs 26 are arranged so that the base part is symmetrical with respect to a longitudinal axis extending through the bore 20 (see FIG. 3 with the longitudinal axis L).

The clamping part 12 has an opening 28 for the passage of the clamping screw 22 as well as a tab 30 at the lower edge in the orientation shown in FIG. 2. The tab 30 is bent in the manner of a hook by slightly more than the material thickness of the body portion 14 of the base part and extends from a supporting portion 32, which is formed at the lower edge of the clamping part 12. Proceeding from the supporting portion 32, the material of the clamping portion extends in several steps towards the region in which the opening 28 is provided.

At the upper edge of the clamping part 12 (in the orientation shown in FIG. 2), the clamping part 12 is provided with a barb 34, which likewise constitutes an embossed portion. The edge protruding from the plane of the clamping part 12 points towards the opening 28 and is located on the side of the clamping part that can be seen in FIG. 2.

A pad 36 made of rubber or another resilient material is mounted between the clamping part 12 and the base part 10. The rubber pad 36 has two lips 38 that cooperate with the barbs 26, 34 at the base part 10 and at the clamping part 12 so that the rubber pad 36 can reliably be retained on the carriage. The horizontally extending bottom of the rubber pad 36 supports the lower edge of a window pane to be accommodated by the carriage.

Finally, a nipple holder 40 is mounted on the base part 10 and can receive a nipple of a cable via which the carriage can be adjusted along the rail of the window lifter. The cable extends through the nipple holder 40, and a nipple mounted on the cable can be fixed between the upper and the lower wall of the nipple holder.

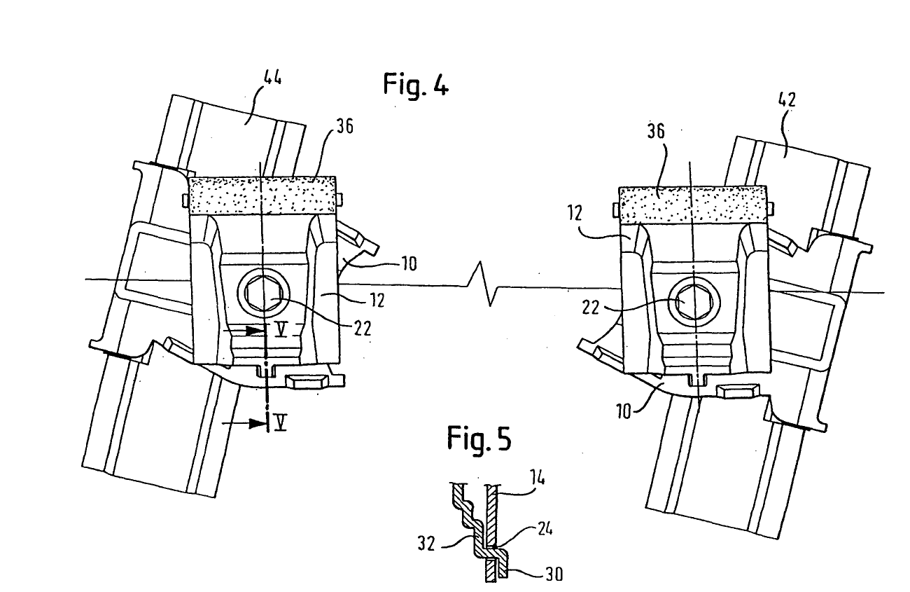

Different possibilities for adapting the carriage to respective mounting situations will now be described with reference to FIGS. 3 and 4.

FIG. 3 schematically shows a front rail 42 and a rear rail 44 of a window lifter. The two rails are mounted in, for instance, the left door of a vehicle. A carriage 10 is movably mounted in each of the rails. In this example, the two carriages 10 have the same structure; the carriage mounted at the front rail 42 is merely rotated by 180° with respect to the carriage mounted at the rear rail 44, as is indicated by the arrow P. Due to the plurality of recesses 24, which together with the tab 30 and the clamping screw 22 form an arresting mechanism, the same clamping part can be mounted at the base part 10 in different positions, as can be seen with reference to FIG. 4.

The clamping part 12 is mounted at the base part 10 such that the tab 30 extends through one of the recesses 24 until the supporting portion 32 of the clamping part 12 abuts at the body portion 14 of the base part 10 (see FIG. 5). This is possible because the tab 30 is bent with respect to the plane of the supporting portion 32. After the clamping screw 22 is screwed into the bore 20, the clamping part 12 is aligned at the base part 10 in a position adapted to the respective mounting position. It can easily be seen that in the present case, in which the base part 10 is rotated by 180°, the two diametrically opposed recesses 24 of a pair of recesses are used in order to mount the base part 10 both at the front rail and at the rear rail.

As will be understood due to a simple geometrical consideration, the base part 10 must be rotated by 180°, namely about an axis which is horizontal with respect to FIGS. 4 and 5, so that it can be used on the front rail on the right side of the vehicle and not on the front rail on the left side of the vehicle. The same is true for the base part disposed at the rear rail. When the clamping part is then mounted at the corresponding base part, the previously unused two recesses are utilized.

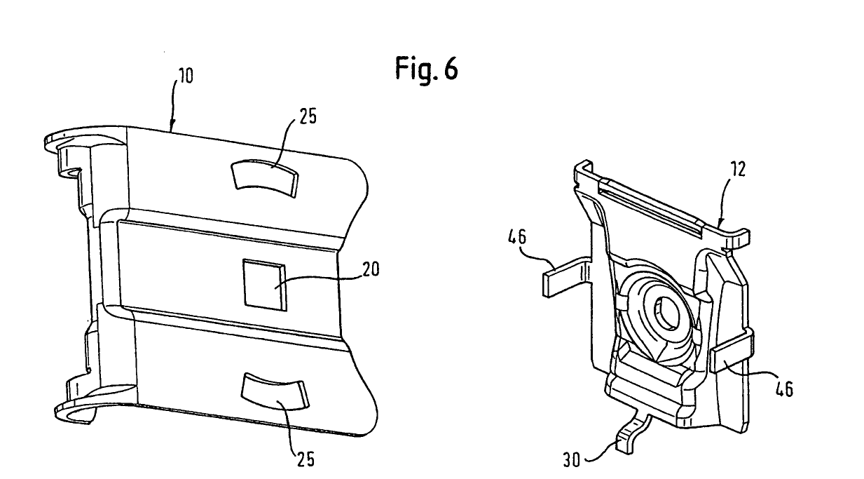

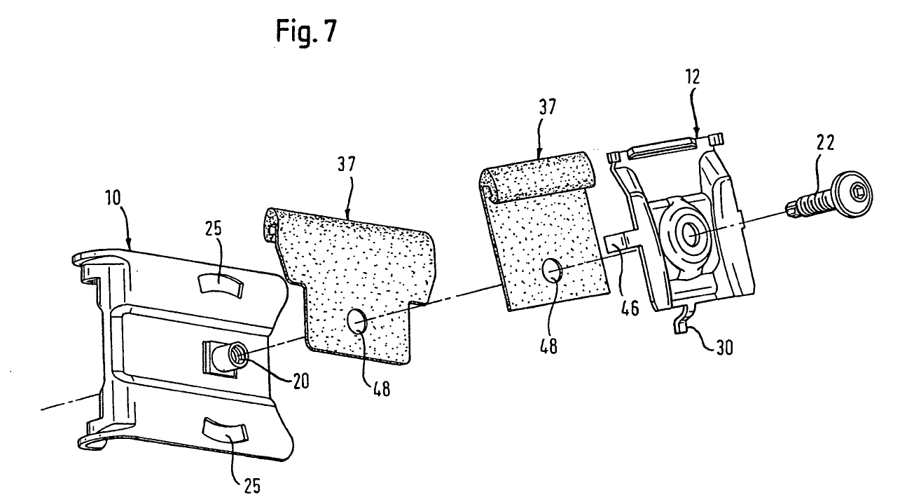

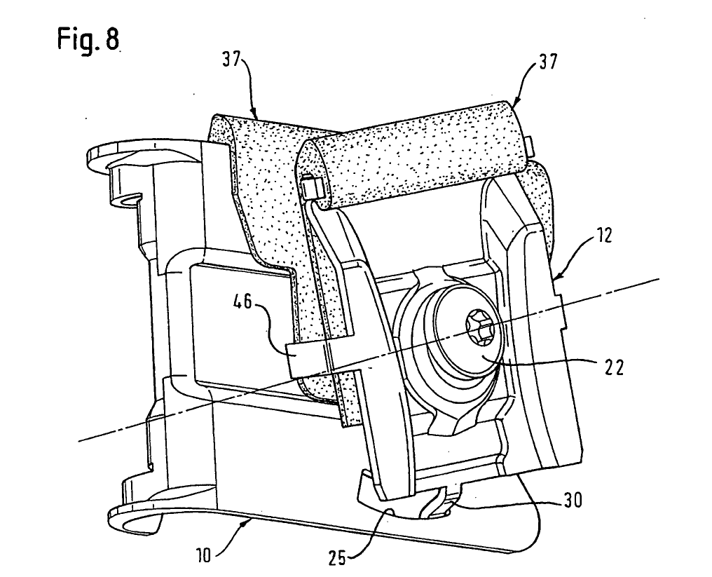

FIGS. 6 to 11 show a carriage according to another embodiment of the invention. For the components described with respect to the first embodiment, the same reference numerals are used and reference is made to the above explanation.

The most essential difference between the first and the second embodiment is that the second embodiment includes a single recess 25 instead of two separate recesses 24 next to each other. This single recess is arcuate and extends approximately over the angular range which in the carriage in accordance with the first embodiment is defined by the two recesses 24. The center of curvature of each recess 25 coincides with the middle axis of the bore 20 for the clamping screw 22.

Another difference between the first and the second embodiments is that the second embodiment has two stop arms 46 at the clamping part 12. These stop arms 46 serve to support the lower edge of a window pane 80 to be accommodated by the carriage. The two stop arms 46 extend approximately vertically to the plane defined by the body of the clamping part 12 toward the base part 10.

Yet another difference between the first and the second embodiments is that the second embodiment has two separate pads 37 that form the rubber pad. Each pad 37 has a through opening 48 that accommodates the clamping screw 22. This serves to fix the pads.

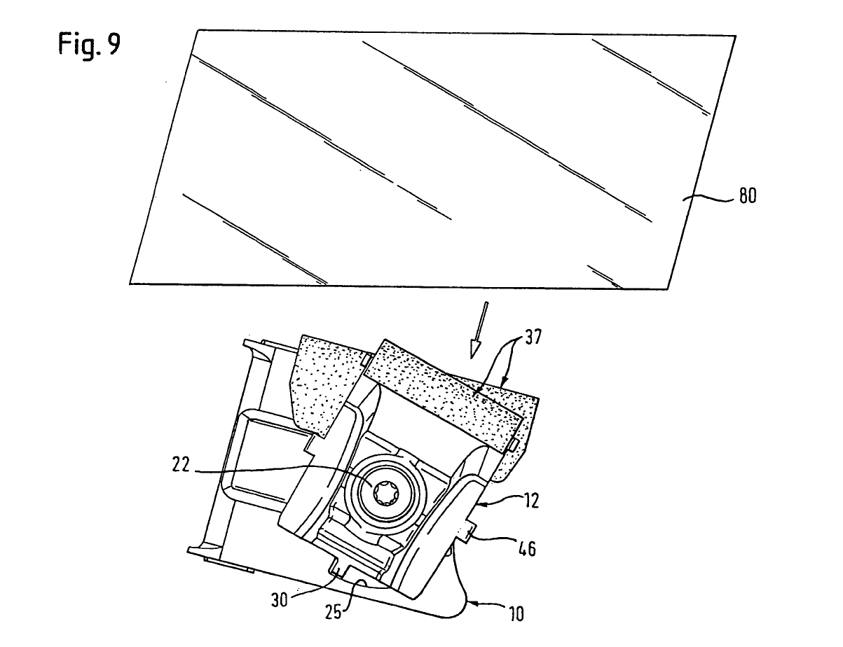

The arcuate recess 25, together with the tab 30, determines the alignment of the clamping part 12 relative to the base part 10 within certain angular limits; note that precise alignment is not predetermined and not required. Thus, it is admissible that while the window pane 80 is mounted at the carriage, the clamping part 12 takes any position, for instance, maximally swiveled in clockwise direction, as is shown in FIG. 9.

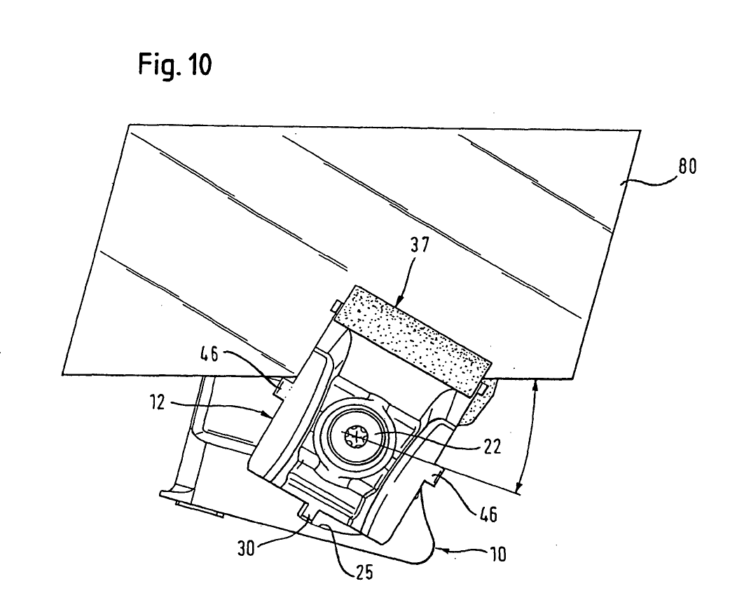

When the window pane is inserted between the two pads and thus between the base part 10 and the clamping part 12, the lower edge of the window pane strikes against one of the stop arms 46 (against the left stop arm in the illustrated example) due to the position of the clamping part 12; as shown in FIG. 10, the left stop arm 4 is located at a higher level than the right stop arm.

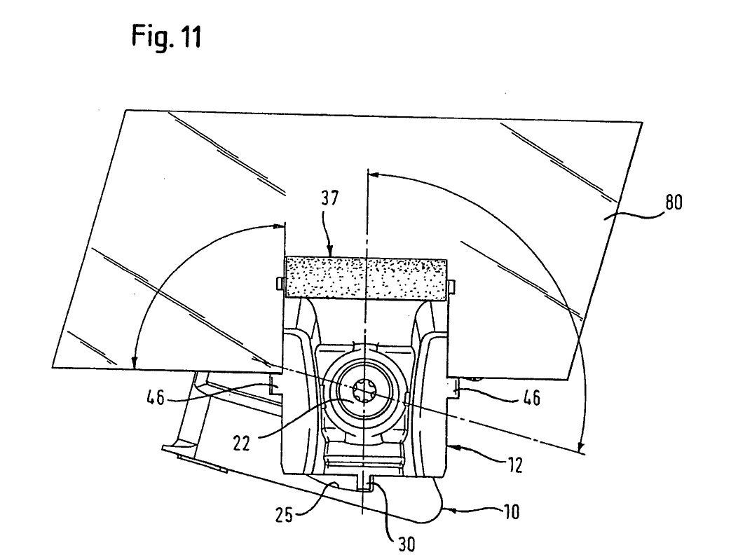

When the window pane 80 is lowered further, the window pane presses the left stop arm 46 downwards, whereby the clamping part is swiveled in a counter-clockwise direction, until both stop arms 46 uniformly abut at the lower edge of the window pane 80 (see FIG. 11). Thus, the clamping part 12 automatically aligns into its optimum position without requiring any preadjustment. This optimum position can be different depending on the type of vehicle without another carriage being required in each case.

It should be understood that various alternatives to the embodiments of the invention described herein may be employed in practicing the invention. It is intended that the following claims define the scope of the invention and that the method and apparatus within the scope of these claims and their equivalents be covered thereby.

1. A carriage for a window lifter, comprising:
a base part that is movably mountable on a rail in a vehicle;
a clamping part mounted on the base part, wherein the base part and the clamping part accommodate a vehicle pane therebetween; and
an arresting mechanism that secures the clamping part on the base part in at least two positions, each position corresponding to a different mounting orientation.

2. The carriage as claimed in claim 1, wherein the arresting mechanism comprises a clamping screw which can be screwed into a bore in the base part so that the clamping part can be tensioned against the base part.

3. The carriage as claimed in claim 2, wherein the carriage is symmetrical with respect to an axis extending through the bore for the clamping screw.

4. The carriage as claimed in claim 1, wherein the arresting mechanism comprises a plurality of recesses and a tab that engages one of said plurality of recesses based on a desired mounting orientation to mount the clamping part to the base part in one of said at least two positions.

5. The carriage as claimed in claim 4, wherein the tab is formed at an end of the clamping part and wherein the recesses are disposed in the base part.

6. The carriage as claimed in claim 5, wherein the plurality of recesses comprise diametrically opposed pairs of recesses.

7. The carriage as claimed in claim 1, wherein the arresting mechanism comprises an elongate recess and a tab that engages a portion of the elongate recess based on the mounting orientation, wherein the tab engages a different portion of the elongate recess for each of said at least two positions.

8. The carriage as claimed in claim 7, wherein the elongated recess is arcuate.

9. The carriage as claimed in claim 1, further comprising a nipple holder that can receive a nipple of a cable via which the carriage can be moved along the rail.

10. The carriage as claimed in claim 1, further comprising at least one resilient pad disposed between the clamping part and the base part, wherein the pad forms a pocket for receiving the vehicle pane.

11. The carriage as claimed in claim 10, further comprising at least one barb on the base part that engages the pad to retain the pad on the clamping part.

12. The carriage as claimed in claim 11, wherein said at least one barb comprises a plurality of barbs, each barb associated with one of said at least two positions of the clamping part.

13. A carriage for a window lifter, comprising:
a base part that is movably mountable on a rail in a vehicle, the base part having a bore, wherein the carriage is symmetrical with respect to an axis extending through the bore;
a clamping part mounted on the base part, wherein the base part and the clamping part accommodate a vehicle pane therebetween;
an arresting mechanism that secures the clamping part on the base part in at least two positions, each position corresponding to a different mounting orientation, wherein the arresting mechanism comprises a clamping screw which can be screwed into the bore in the base part so that the clamping part can be tensioned against the base part; and
at least one resilient pad disposed between the clamping part and the base part, wherein the pad forms a pocket for receiving the vehicle pane.

14. The carriage as claimed in claim 13, wherein the plurality of recesses comprise diametrically opposed pairs of recesses disposed with respect to a middle axis of the bore in the base part and a tab that engages one of said plurality of recesses based on a desired mounting orientation to mount the clamping part to the base part in one of said at least two positions, and.

15. The carriage as claimed in claim 14, wherein the tab is formed at an end of the clamping part and wherein the recesses are disposed in the base part.

16. The carriage as claimed in claim 13, wherein the arresting mechanism further comprises an arcuate elongate recess and a tab that engages a portion of the elongate recess based on a desired mounting orientation, wherein the tab engages a different portion of the elongate recess for each of said at least two positions, and wherein a center of curvature of the elongated recess aligns with a center of the clamping screw.

17. The carriage as claimed in claim 13, further comprising a nipple holder that can receive a nipple of a cable via which the carriage can be moved along the rail.

18. The carriage as claimed in claim 13, further comprising at least one barb on the base part that engages a lip on the pad to retain the pad on the clamping part.

19. The carriage as claimed in claim 18, wherein said at least one barb comprises a plurality of barbs, each barb associated with one of said at least two positions of the clamping part.
